(19) United States
(12) Patent Application Publication
(10) Pub. No.: US 2017/0337643 A1
(43) Pub. Date: Nov. 23, 2017

(54) REFERENCE ARCHITECTURE FOR MARKET FORECASTING USING REAL-TIME ANALYTICS

(71) Applicant: General Electric Company, Schenectady, NY (US)

(72) Inventors: Leonides Rodil De OCAMPO, San Ramon, CA (US); Nandakumar IYENGAR, San Ramon, CA (US); Anwar AHMED, San Ramon, CA (US)

(21) Appl. No.: 15/161,433

(22) Filed: May 23, 2016

(51) Int. Cl. G06Q 50/06; G06Q 30/02; H04L 29/08

(52) U.S. Cl. CPC G06Q 50/06; H04L 67/10; G06Q 30/0202; H04L 67/02

(57) ABSTRACT

According to some embodiments, system and methods are provided comprising one or more assets operative to generate one or more data elements; a collection device at a first tier, wherein the collection device is operative to receive one or more generated data elements; a central storage device at a third tier, wherein the third tier is located in a computing cloud, and wherein the central storage device is operative to receive the one or more generated data elements from the collection device; one or more analytic modules at a fourth tier, wherein the fourth tier is located in the computing cloud, and wherein the one or more analytic modules is operative to receive the one or more generated data elements from the central storage device and generate an analysis based on the one or more generated data elements; and a processing and reporting module at a fifth tier, wherein the fifth tier is located in the computing cloud, and wherein the processing and reporting module is operative to report the analysis to a user, wherein the user is remote from the computing cloud; wherein the computing cloud is remote from the one or more assets and wherein each tier is a segregated computing environment. Numerous other aspects are provided.

### BACKGROUND

Wind turbines are contributors to power generation to supply electrical grids. Generally, a wind turbine includes a turbine having multiple blades. The blades transform the wind energy into a mechanical rotational torque that drives one or more generators. The generator converts the rotational mechanical energy to electrical energy, which is fed into a utility grid via at least one electrical connection. Some power generation developers have one or more wind farms having many (e.g., one hundred or more) wind turbine generators, making wind turbine generators an increasingly feasible source of power for the power grid.

Often, efficient power production in a wind farm makes use of data collected from the many sensors at the wind farm and analytics applied thereto for power generation forecasts/predictions. However, forecasts may be most useful in real-time, and with the large number of sensors providing data, it may be difficult to obtain real-time forecasts. Additionally, with large volumes of data, it may be challenging to securely transmit the data with no loss or gaps in the data.

Therefore, it would be desirable to provide a system and method that more efficiently provides analytic systems with access to data provided by wind farms.

### BRIEF DESCRIPTION

According to some embodiments, a system includes one or more assets operative to generate one or more data elements; a collection device at a first tier, wherein the collection device is operative to receive one or more generated data elements; a central storage device at a third tier, wherein the third tier is located in a computing cloud, and wherein the central storage device is operative to receive the one or more generated data elements from the collection device; one or more analytic modules at a fourth tier, wherein the fourth tier is located in the computing cloud, and wherein the one or more analytic modules is operative to receive the one or more generated data elements from the central storage device and generate an analysis based on the one or more generated data elements; and a processing and reporting module at a fifth tier, wherein the fifth tier is located in the computing cloud, and wherein the processing and reporting module is operative to report the analysis to a user, wherein the user is remote from the computing cloud; wherein the computing cloud is remote from the one or more assets and wherein each tier is a segregated computing environment.

According to some embodiments, a method includes generating one or more data elements at one or more assets; receiving the one or more generated data elements at a collection device at a first tier; receiving at a central storage device in a third tier located at a computing cloud, the one or more generated data elements from the collection device; generating an analysis of the one or more generated data elements at one or more analytic modules in a fourth tier located at the computing cloud, after receipt at the analytic module of the one or more generated data elements from the central storage device; reporting the analysis, via a reporting module located at the computing cloud, to a user remote from the cloud; wherein the computing cloud is remote from the one or more assets; and wherein each tier is a segregated computing environment.

A technical effect of some embodiments of the invention is an improved technique and system for providing energy forecasts. A benefit of embodiments is that by more efficiently providing data to analytic modules, forecasting or predicting an amount of energy produced by a wind farm, or a turbine at a wind farm, may be more efficient and timely. More efficient energy production forecasting may provide for more efficient and accurate interaction with the energy market. Another benefit of embodiments may be the ability to create more accurate analytic models that dynamically learn from historic data—providing more efficient energy forecasting based on historic data across a fleet (e.g., more than one wind farm) as well as external data from providers like the National Oceanic and Atmospheric Administration (NOAA).

The inventors also note that a challenge for conventional forecasters is that conventional forecasters typically provide one-off solutions, focusing development and infrastructure at a per farm level, which may prevent proper operational scaling of solutions across the fleet and resource scaling. For example, conventionally, forecasting systems are developed close to the source of data generation, which allows for collection, processing an analytics from one monolithic application. This approach, however, limits the scope of data from which the analytics can learn from to the data present from that one source. It also prevents the scaling of computer resources, either for data storage, analytic execution or service invocation. Embodiments provide a cloud-based system and platform designed to scale resources as needed per client, and provide real-time forecasting based on analytics of data scoped across a large time window and external data sets.

With this and other advantages and features that will become hereinafter apparent, a more complete understanding of the nature of the invention can be obtained by referring to the following detailed description and to the drawings appended hereto.

Other embodiments are associated with systems and/or computer-readable medium storing instructions to perform any of the methods described herein.

### DRAWINGS

FIG. 1 illustrates a system according to some embodiments.

FIG. 2 illustrates a flow diagram according to some embodiments.

FIG.3 illustrates a block diagram of a system according to some embodiments.

### DETAILED DESCRIPTION

Wind turbines are contributors to power generation to supply electrical grids. Generally, a wind turbine includes a turbine having multiple blades. The blades transform the wind energy into a mechanical rotational torque that drives one or more generators. The generator converts the rotational mechanical energy to electrical energy, which is fed into a utility grid via at least one electrical connection. Some power generation developers have one or more wind farms having many (e.g., one hundred or more) wind turbine generators, making wind turbine generators an increasingly feasible source of power for the power grid.

Often, efficient power production in a wind farm makes use of data collected from the many sensors at the wind farm and analytics applied thereto for power generation forecasts/predictions. However, forecasts may be most useful in real-time, and with the large number of sensors providing data, it may be difficult to obtain real-time forecasts. Additionally, with large volumes of data, it may be challenging to securely transmit the data with no loss or gaps in the data.

While examples used in descriptions of embodiments of the invention may be described with respect to one or more wind turbines or one or more wind farms, embodiments may be applicable to any analytic system.

Some embodiments provide a method and system for a reference architecture for wind farm market power production forecasting across a fleet of wind farms. In some embodiments, the reference architecture may provide two or more segregated computing environments (e.g., tiers), each including one or more devices or modules, that may interact with each other to generate a power production forecast. A benefit of the segregated computing environments may be that the environments may be easily swapped out such that a problem with one environment may not negatively affect the other environments (e.g., all environments may not be sensitive to network issues). In some embodiments, some of the tiers may be located in a computing cloud, located remotely from the data-generating fleet of wind farms, while others may be located geographically close to the data-generating fleet wind farms. Embodiments use real-time analytic modules allowing for a flexible and reliable system that may provide accurate power forecasting for wind farm operators using models that continually learn from historic data. The accurate power forecasts may allow users to more accurately bid into power markets. Having multiple tiers of processing may assure data is properly collected, processed and stored. The central nature (e.g., computing cloud) of data management and analytics (via the analytic modules) may allow for models to learn from larger data sets (e.g., from multiple wind farms, as opposed to just one). In some embodiments, the central nature of data management and analytics may provide a foundation for building and applying models that cross enterprise, and organizations (as permitted by customers).

As weather conditions fluctuate, potential production at the wind farm also may fluctuate, and analytics using accurate real-time data, external data, and historic data may allow for adjustments in the operation of the wind farm in real-time to capture all available energy. Additionally, data from the wind farms as well as historic data and external data sources may provide more accurate future forecasting (e.g., day-ahead and week-ahead). Accurate future forecasting may have applications in the energy market in terms of energy trading, and may be used to more accurately interact (e.g. bid) into markets. For example, traditionally, energy speculations may be different from the energy actually produced (e.g., energy producers either over-produce or under-produce). The ability to accurately predict energy production may allow for the maximization of revenue and output.

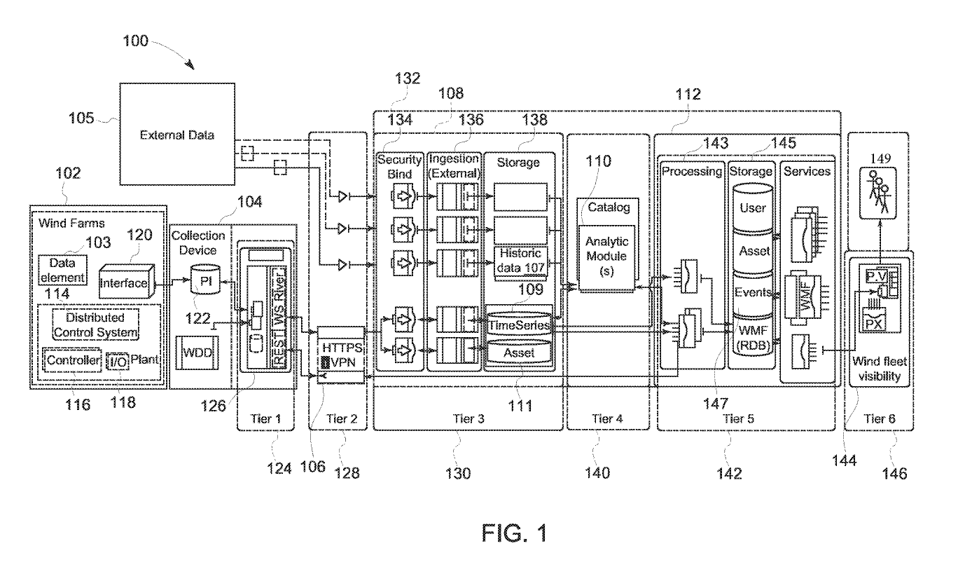

Turning to FIG. 1, a block diagram of a system 100 including an asset 102 according to some embodiments is provided. Although the system 100 includes one set of assets 102, the system and method described herein may be applied to any system 100 containing any number of a variety of assets 102. While two or more wind farms (a “fleet”) may be an example of the assets described herein, any suitable sets of assets may be used, for example, a fossil fuel power plant or nuclear plant. As used herein, the terms “wind farms,” “asset,” and “sets of asset(s)” may be used interchangeably. The system 100 may also include a collection device 104, a connectivity module 106, a central storage device 108, one or more analytic modules 110, and a processing and reporting module 112.

The asset 102 may include one or more sensors (not shown) to obtain data elements 103 from the asset 102. In some embodiments, the sensor may be configured to obtain at least one kind of data element 103. For example, the sensor may be configured to take temperature measurements, pressure measurements, humidity level measurements, or any other suitable measurements used for weather forecasting.

In some embodiments, the asset 102 may also include a distributed control system 114 used in the operation of the asset 102. The distributed control system 114 may include a controller 116 and one or more input/output devices 118.

In one or more embodiments, the asset 102 may also include an interface 120 for communicating with the collection device 104. In one or more embodiments, the sensors may transmit the data elements 103 to the collection device 104. The interface 120 may use any suitable communication protocol to transmit the data elements 103 and to receive instructions.

In some embodiments, the collection device 104 may include a memory/storage device 122. The collection device 104 may be included in a first processing tier 124 (“first tier”) that may include software for communication with the central storage device 108 to push the data elements 103 thereto, and with the processing and reporting module 112, via the communication module 106. In some embodiments, the first tier 124 may include one or more protocols 126 (e.g., Web Socket (WS) River and REST) for data communication services.

Each tier described herein may comprise one or more non-transient computer-readable mediums and one or more processors, such that each tier is a segregated processing environment, having at least one server for executing tasks. Each tier being a segregated processing environment may make each tier independent with respect to resource dependencies, with each tier being its own subsystem.

The communication module 106, in one or more embodiments, may be included in a second processing tier 128 (“second tier”) that may securely bind and transmit the data elements 103 to the central storage device 108. In one or more embodiments, the communication module 106 may represent a secure communication and transmission service that may connect different sites to a cloud computing environment. In one or more embodiments, the communication module 106 may use https, virtual private network (“vpn”) or any other suitable secure communication protocol and/or network service to bind and transmit the data elements 103. In some embodiments, the communication module 106 may also securely bind and transmit external data elements 105 from external data sources (e.g., Pulse point, MISO, Market data, National Oceanic Atmospheric Administration) to the central storage device 108. In some embodiments, historic data 107 may be collected for both operational systems (e.g., sensors) and external systems 105.

The central storage device 108 may be included in a third processing tier 130 (“third tier”). In one or more embodiments, the central storage device 108 may be located in a computing cloud 132, remote from the asset 102 and communication module 106. As is well known in the art, “computing cloud,” often referred to as simply “the cloud,” is the delivery of on-demand computing resources (e.g., networks, network bandwidth, servers, processing, memory, storage, applications, data centers, virtual machines and services, etc.) over the Internet on a pay-for-use basis. The computing cloud may provide physical infrastructure and applications that are remotely accessed by a local system.

As referred to above and here, a “local system” may also comprise one or more servers. The server(s) may comprise at least one processor that executes instructions for use in energy production forecasting. The local system may comprise one or more non-transient computer-readable mediums and one or more processors that may execute instructions stored on a non-transient memory to run an application.

As used herein, the term “local” may indicate that devices are connected directly to one another and/or connected over a local area network. The term “local” is also used for convenience herein to distinguish hardware that is not part of a computing cloud, where the computing cloud is located remotely relative to a (local) system. It is understood that devices that connect to each other over the Internet, rather than directly or over a local area network (or similar), are not local to one another. On the other hand, the term “remote” may indicate that devices communicate with one another over the Internet or some other non-local network. Systems that communicate in this fashion are deemed “remote” from one another for convenience of discussion herein.

In some embodiments, the central storage device 108 may include at least three sections: a security bind 134, an ingestion 136 and a storage 138. As used herein, the term “Security bind” may refer to a mutually confirmed (sender and receiver) connection where both ends are assured the identity of the other. The ingestion section 136 may include a specific protocol to extract the data elements 103 for further processing. The storage section 138 may include a database (e.g., time series database 109, asset database 111) for storing the data elements 103.

The database may comprise any query-responsive data source or sources that are or become known, including but not limited to a structured-query language (SQL) relational database management system. The database may comprise a relational database, a multi-dimensional database, an eXtendable Markup Language (XML) document, or any other data storage system storing structured and/or unstructured data. The data of the database may be distributed among several relational databases, dimensional databases, and/or other data sources. Embodiments are not limited to any number or types of data sources.

A catalog of one or more analytic modules 110 may be included in a fourth processing tier 140 (“fourth tier”). In one or more embodiments, the one or more analytic modules 110 may be located in the computing cloud 132, remote from the asset 102 and communication module 106. In some embodiments, the one or more analytic modules 110 may receive the data elements 103 from the central storage device 108 and use these data elements 103 to generate (e.g., process, linearize and derive a position-forecast) an analysis.

In one or more embodiments, the particular analytic module 110 used may be based on the user-query. In one or more embodiments, the analytic module(s) 110 may use at least one of external data 105 and historical data 107 to generate the analysis. Examples of methods of analyzing the data may include, for example, numerical calculations, numerical analysis, pattern recognition and modeling. In one or more embodiments, the analytic module(s) 110 may use coefficient based models to analyze the data elements 103/105, as the coefficient based models may dynamically learn from historic data. Other suitable types of models that dynamically learn from historic data may be used. Other suitable types of analyses may be used.

In one or more embodiments, the fourth tier 140 may also include any suitable analytic execution engine.

The processing and reporting module 112 may be included in a fifth processing tier 142 (“fifth tier”). In one or more embodiments, the processing and reporting module 112 may be located in the computing cloud 132, remote from the asset 102 and the communication module 106. In some embodiments, the processing and reporting module 112 may report the analysis and provide transaction data and services. In one or more embodiments, a processing portion 143 of the processing and reporting module 112 may coordinate between the central storage device 108 and the analytic module(s) 110 to pull the data from the central storage device 108 into the analytic module(s) 110 for analysis, and then the resulting analysis may be stored in a storage portion 145 of the processing and reporting module 112. In some embodiments, the processing and reporting module 112 may return the analysis to the first tier 124 for storage at local repositories, for example, and may transmit the data to a visualization module 144. In one or more embodiments, in the storage portion 145 of the processing and reporting module 112 an event 147 (e.g., changing the operation of the asset 102) may be associated with the analyzed data. For example, based on the analysis, hydraulic pressure in the asset 102 is high, so the system 100 may send an alarm or another signal (e.g., event) to the asset 102.

In one or more embodiments, the system 100 further includes the visualization module 144 in a sixth processing tier 146 (“sixth tier”). In one or more embodiments, the sixth tier 146 is remote from the computing cloud 132. In one or more embodiments, the visualization module 144 may provide an interface and/or display to users 149 the actual values that are received from the sensors and the forecasted values resulting from the analysis. In some embodiments, the visualization may be used to compare with actual data to understand the accuracy of the forecast. For examples, the visualization module 144 may display graphs that show the trend of the actual power production to the forecasted values.

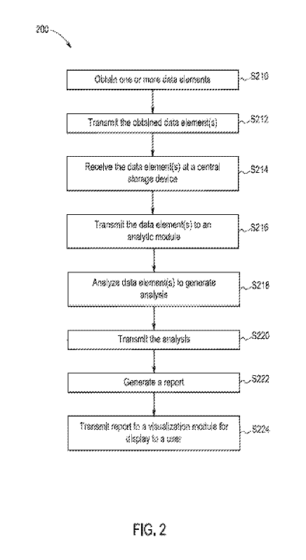

Turning to FIG. 2, an example of operation according to some embodiments is provided. In particular, FIG. 2 is a flow diagram of a process 200 according to some embodiments. Process 200 and other processes described herein may be performed using any suitable combination of hardware (e.g., circuit(s)), software or manual means. In one or more embodiments, the system 100 is conditioned to perform the process 200 such that the system is a special-purpose element configured to perform operations not performable by a general-purpose computer or device. Software embodying these processes may be stored by any non-transitory tangible medium including a fixed disk, a floppy disk, a CD, a DVD, a Flash drive, or a magnetic tape. Examples of these processes will be described below with respect to embodiments of the system, but embodiments are not limited thereto.

Initially, at S210, the sensor obtains a measurement (e.g., “data element”) of the asset 102. The measurement may be obtained via conventional operation of the sensor. Then, in S212, the asset 102 transmits the obtained data element(s) via the interface 120 to the collection device 104. In one or more embodiments, the obtained data element(s) is “raw” data in that it has not been analyzed or manipulated. In some embodiments, the obtained data element(s) have been analyzed (e.g., to determine the quality) and/or manipulated (e.g., cleansed) prior to transmission.

Then in S214, the data elements 103/105 are received at the central storage device 108 via the communication module 106. In some embodiments, at least part of the data elements 103/105 may be extracted by the ingestion section 136 for storage in one or more databases in the storage section 138.

The processing portion 143 of the processing and reporting module 112 may issue a call to pull the data from the storage section 138 of the central storage device 108 into the analytic module(s) 110 in S216.

Then in 5218, the analytic module(s) 110 analyzes the generated data element(s) 103, resulting in an analysis. As described above, the analytic module(s) 110 may analyze the generated data element(s) and at least one of the external data element 105 and historic data element 107 to generate the analysis. In one or more embodiments, the analysis may be a forecast of energy production of the asset 102. For example, the analysis may be a prediction of the amount of energy produced by at least one of the wind farm and the fleet of wind farms in real-time, for the next 24 hours, and for the next seven days. Continuing with example, based on the generated wind speed data element 103 at two wind farms 102, external data elements 105 provided by the NOAA about the weather over the next 24 hours, and historic data elements 107 related to these parameters, the analytic module(s) 110 may predict the amount of energy produced by the wind farms 102 over the next 24 hours.

The analytic module(s) 110 may transmit the analysis in S220. In some embodiments, the analytic module(s) 110 may transmit the analysis to the storage section 138 of the central storage device 108 and/or may transmit the analysis to the processing and reporting module 112. Then in S222, the processing and reporting module 112 may generate a report of the analysis, and may then transmit the report to the visualization module 144 in S224 for display to the user. In some embodiments, the analysis may be used to at least one of allow a user to determine with more accuracy their interactions (e.g. bid) in energy markets, compare the predicted values with actual values to understand the accuracy of the forecast/analysis, and operate an asset based on the analysis. In some embodiments, the analysis transmitted to processing and reporting module 112 may then be further directly transmitted to the collection device 104, via the communication module 106, (and subsequently to the asset 102) for operation of the asset 102 without further user interaction. In some embodiments, transmission of the analysis to the collection device 104 may occur at least one of prior to, at the same time, or at substantially the same time as generation and transmission of the report to the visualization module in S224. In some embodiments, the user may view the display of the report and then operate the asset 102 in response to the report.

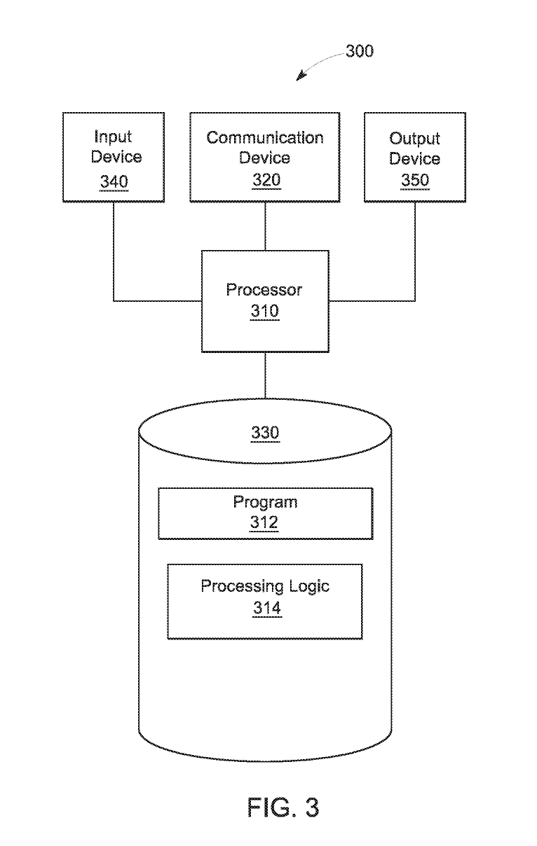

Note the embodiments described herein may be implemented using any number of different hardware configurations. For example, FIG. 3 illustrates a market forecasting platform 300 that may be, for example, associated with the system 100 of FIG. 1. The market forecasting platform 300 comprises a market forecasting processor 310 (“processor”), such as one or more commercially available Central Processing Units (CPUs) in the form of one-chip microprocessors, coupled to a communication device 320 configured to communicate via a communication network (not shown in FIG. 3). The communication device 320 may be used to communicate, for example, with one or more users. The market forecasting platform 300 further includes an input device 340 (e.g., a mouse and/or keyboard to enter information about the measurements and/or assets) and an output device 350 (e.g., to output and display the data and/or recommendations).

The processor 310 also communicates with a memory/storage device 330. The storage device 330 may comprise any appropriate information storage device, including combinations of magnetic storage devices (e.g., a hard disk drive), optical storage devices, mobile telephones, and/or semiconductor memory devices. The storage device 330 may store a program 312 and/or market forecasting logic 314 for controlling the processor 310. The processor 310 performs instructions of the programs 312, 314, and thereby operates in accordance with any of the embodiments described herein. For example, the processor 310 may receive data elements from the sensors and then may apply the analytic module(s) 110 via the instructions of the programs 312, 314 to analyze the data and transmit the analysis.

The programs 312, 314 may be stored in a compressed, uncompiled and/or encrypted format. The programs 312, 314 may furthermore include other program elements, such as an operating system, a database management system, and/or device drivers used by the processor 310 to interface with peripheral devices.

As used herein, information may be “received” by or “transmitted” to, for example: (i) the platform 300 from another device; or (ii) a software application or module within the platform 300 from another software application, module, or any other source.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein; by way of example and not limitation, an analytic module. The method steps can then be carried out using the distinct software modules and/or sub-modules of the system, as described above, executing on one or more hardware processors 310 (FIG. 3). Further, a computer program product can include a computer-readable storage medium with code adapted to be implemented to carry out one or more method steps described herein, including the provision of the system with the distinct software modules.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

1. A system comprising:
one or more assets operative to generate one or more data elements;
a collection device at a first tier, wherein the collection device is operative to receive one or more generated data elements;
a central storage device at a third tier, wherein the third tier is located in a computing cloud, and wherein the central storage device is operative to receive the one or more generated data elements from the collection device;
one or more analytic modules at a fourth tier, wherein the fourth tier is located in the computing cloud, and wherein the one or more analytic modules is operative to receive the one or more generated data elements from the central storage device and generate an analysis based on the one or more generated data elements; and
a processing and reporting module at a fifth tier, wherein the fifth tier is located in the computing cloud, and wherein the processing and reporting module is operative to report the analysis to a user, wherein the user is remote from the computing cloud;
wherein the computing cloud is remote from the one or more assets and wherein each tier is a segregated computing environment.

2. The system of claim 1, further comprising a second tier including a connectivity module operative to securely bind and transmit one or more generated data elements.

3. The system of claim 2, wherein the first tier and the third tier communicate with each other via the second tier using one of https and vpn.

4. The system of claim 1, further comprising at least one of historic data and one or more external data sets.

5. The system of claim 4, wherein the analytic module is operative to receive at least one of the historic data and the one or more external data sets and to generate the analysis based on the one or more generated data elements and at least one of the historic data and the one or more external data sets.

6. The system of claim 4, wherein the one or more analytic modules further comprise one or more models to perform the analysis; and wherein the one or more models dynamically learn from the historic data.

7. The system of claim 4, wherein the historic data is related to a fleet of assets.

8. The system of claim 5, wherein the fifth tier is operative to receive the generated analysis from the fourth tier and transmit the analysis to the first tier.

9. The system of claim 8, wherein the generated analysis is a predicted amount of energy produced by the asset.

10. The system of claim 8, wherein the generated analysis is used as the basis, in part, to determine whether to interact with at least one energy market.

11. A method comprising:
generating one or more data elements at one or more assets;
receiving the one or more generated data elements at a collection device at a first tier;
receiving at a central storage device in a third tier located at a computing cloud, the one or more generated data elements from the collection device;
generating an analysis of the one or more generated data elements at one or more analytic modules in a fourth tier located at the computing cloud, after receipt at the analytic module of the one or more generated data elements from the central storage device;
reporting the analysis, via a reporting module located at the computing cloud, to a user remote from the cloud;
wherein the computing cloud is remote from the one or more assets; and
wherein each tier is a segregated computing environment.

12. The method of claim 11, further comprising:
securely binding and transmitting the one or more generated data elements via a connectivity module at a second tier.

13. The method of claim 12, further comprising
communicating between the first tier and the third tier via one of https and vpn at the second tier.

14. The method of claim 11, further comprising:
providing at least one of historic data and one or more external data sets.

15. The method of claim 14, further comprising:
receiving at the one or more analytic module at least one of the historic data and the one or more external data sets; and
generating the analysis based on the one or more generated data elements and at least one of the historic data and the one or more external data sets.

16. The method of claim 14, wherein the one or more analytic modules further comprise one or more models to perform the analysis; and wherein the one or more models dynamically learn from the historic data.

17. The method of claim 14, wherein the historic data is related to a fleet of assets.

18. The method of claim 15, further comprising:
receiving the generated analysis at the fifth tier from the fourth tier; and
transmitting the generated analysis from the fifth tier to the first tier.

19. The method of claim 18, further comprising:
using generated analysis, in part, to determine an interaction with at least one energy market.

20. The method of claim 18, wherein the generated analysis is a prediction of the amount of energy produced by the asset.
